(19) United States
(12) Patent Application Publication
(10) Pub. No.: US 2016/0041737 A1
(43) Pub. Date: Feb. 11, 2016

(54) SYSTEMS, METHODS AND COMPUTER PROGRAM PRODUCTS FOR ENLARGING AN IMAGE

(71) Applicant: EyeEm Mobile GmbH, Berlin (DE)

(72) Inventors: Matias Castello, Berlin (DE); Markus Spiering, San Francisco, CA (US)

(73) Assignee: EyeEm Mobile GmbH, Berlin (DE)

(21) Appl. No.: 14/453,185

(22) Filed: Aug. 6, 2014

(51) Int. Cl. G06F 3/0484; G06F 3/0488

(52) U.S. Cl. CPC G06F 3/04847; G06F 3/0488

(57) ABSTRACT

A system, method, and computer program product for enabling a user to enlarge a displayed image on a user device. A method of the present invention comprises requesting an image selected by a user from a remote device and receiving said image. The method includes displaying the received image on the user device and receiving a single user input indicating a desired zoom location. The method further includes enlarging the displayed image in response to said input, wherein the vertical height of the image matches the vertical height of the user device display screen. The method further includes downloading from the remote device a high resolution version of the image and displaying the high resolution version in place of the enlarged image.

### TECHNICAL FIELD

The present invention relates generally to systems, methods, and computer program products for enabling users to better display and view images. More particularly, the present invention relates to zooming-in to high resolution images with a single user input.

### BACKGROUND OF THE INVENTION

In conventional image display applications, zooming-in on an image requires a user to perform multiple steps. One widely-used method requires the user to first tap on an image thumbnail to display a picture. The user then places two pinched-together fingers onto the display and zooms-in by moving the fingers apart to expand the image. This method requires that the user perform multiple actions, reducing speed and efficiency. Also, after the user has expanded the image, the image may not be zoomed to the desired depth or to the desired location and may require the user to continue adjusting the image. Even further, the enlarged image is usually just a scaled copy of the displayed image. This method of zooming yields a low-quality image due to poor image resolution.

Another widely-used gesture for zooming is for a user to double-tap on an image. Although this method improves on the previous method by allowing a user to zoom-in closer to their desired location, this method still retains the issues of requiring multiple actions from the user, presenting only a scaled version of the displayed image, and requiring the user to adjust the image if the correct zoom location is missed or the depth is inadequate.

There is a need for a system, method, and computer program product that enables users to quickly, efficiently, and accurately zoom in on a desired location of an image, while also displaying a high resolution image.

### SUMMARY OF THE INVENTION

The present invention enables users to quickly, efficiently, and accurately zoom-in on a desired location of an image, while also displaying a high resolution image. A user is able to quickly zoom into an image displayed on a device using a single input action. The single input represents the desired zoom location, indicating where the user wants to center the enlarged image. In response to the user input, the user device requests a high resolution image from a remote device that stores the high resolution image. The user device received the high resolution image and displays the received image to the user.

Particular embodiments of the present invention are directed to systems, methods, and computer program products for zooming-in on and enlarging an image displayed on a user device.

In one particular embodiment, a method for enabling a user to enlarge an image displayed on a user device includes requesting, by the user device, an image selected by the user from a remote device. The method further includes receiving at the user device the requested image. The method further includes displaying on the user device the received image. The method further includes receiving a single input at the user device indicating a desired zoom location. The method further includes enlarging, in response to the single input, the displayed image, wherein the vertical height of the enlarged image equals the vertical distance of the user device screen and the desired zoom location centers the enlarged image horizontally. The method further includes downloading from the remote device to the user device, in response to the single input, a high resolution version of the image. The method further includes displaying the high resolution version of the image in place of the enlarged image.

In one particular embodiment, a user device for enabling a user to enlarge an image displayed on a user device received from a remote device comprises a processor, a memory coupled to the processor, a display screen coupled to the processor, and a network interface coupled to the processor. The processor is configured to receive a request from the user for an image. The processor is further configured to transmit, using the network interface, the request to the remote device. The processor is further configured to receive, using the network interface, from the remote device the requested image. The processor is further configured to display the received image on the display screen. The processor is further configured to receive a single input from the user indicating a desired zoom location. The processor is further configured to enlarge, in response to the single input, the displayed image, wherein the vertical height of the enlarged image equals the vertical distance of the display screen and the desired zoom location centers the enlarged image horizontally. The processor is further configured to download from the remote device, in response to the single input, a high resolution version of the image. The processor is further configured to display the high resolution version of the image in place of the enlarged image.

In one particular embodiment, a computer program product enabling a user to enlarge a displayed image comprises a non-transitory computer readable medium storing computer readable program code embodied in the medium. The computer program product further comprises program code for causing a user device to receive a request from a user for an image. The computer program product further comprises program code for causing the user device to transmit the request to a remote device. The computer program product further comprises program code for causing the user device to receive the requested image. The computer program product further comprises program code for causing the user device to display the received image. The computer program product further comprises program code for causing the user device to receive a single input from the user indicating a desired zoom location. The computer program product further comprises program code for causing the user device to enlarge the image displayed on the user device screen, wherein the vertical height of the enlarged image equals the vertical distance of the display screen and the desired zoom location centers the enlarged image horizontally. The computer program product further comprises program code for causing the user device to download from the remote device, in response to the single input, a high resolution version of the image. The computer program product further comprises program code for causing the user device to display the high resolution version of the image in place of the enlarged image.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements.

FIG. 1 illustrates an exemplary architecture of a communication system in accordance with exemplary embodiments of the present invention.

FIG. 2 is a block diagram of a user device in accordance with exemplary embodiments of the present invention.

FIG. 3 is a block diagram of a remote device in accordance with exemplary embodiments of the present invention.

FIG. 4 is an exemplary screen of a requested image in accordance with exemplary embodiments of the present invention.

FIG. 5a is an exemplary screen of a requested image in accordance with exemplary embodiments of the present invention.

FIG. 5b is an exemplary screen of a selection made via single user input on the image indicating desired zoom location in accordance with exemplary embodiments of the present invention.

FIG. 5c is an exemplary screen displaying the enlarged image in accordance with exemplary embodiments of the present invention.

FIG. 6 is an exemplary screen of a viewport being movable horizontally in accordance with exemplary embodiments of the present invention.

FIG. 7 is a flow diagram illustrating steps of a method for enlarging an image in accordance with exemplary embodiments of the present invention.

### DETAILED DESCRIPTION

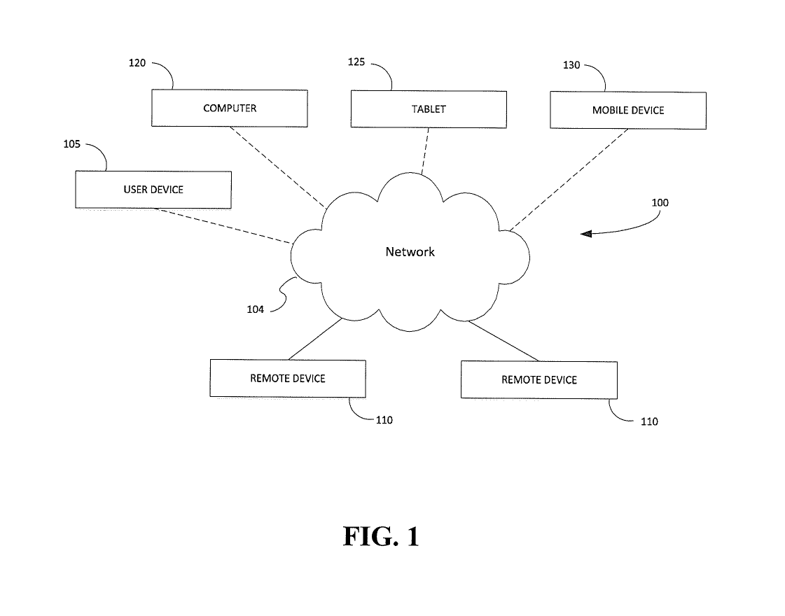

Referring to FIGS. 1-7, exemplary methods, systems, and computer program products for enabling a user to enlarge a displayed image on a user device are provided.

Referring now to FIG. 1, an exemplary architecture of a communication system in accordance with embodiments of the present invention is illustrated. System 100 includes at least one remote device 110 that is configured to communicate with one or more user devices 105 through a communications network 104 (e.g., the internet). Examples of user devices include a computer 120 (e.g., laptop or desktop), a tablet 125 (e.g., an iPad), and a mobile device 130 (e.g., a smartphone, such as, for an example, an iPhone). An example of a remote device 110 includes a server. The system, method and computer program product of the present invention can, for example, be deployed as a user/client-server implementation, as an ASP model, or as a standalone application running on a user device 105.

The user device 105 can be configured to communicate with one or more remote devices 110 via the network 104. Remote devices 110 are configured to generate, maintain, and host the computer program product in one embodiment. The remote devices 110 generate, maintain and host web pages (e.g., HTML documents) that embody the present invention. The remote devices 110 include services associated with rendering dynamic web pages, such as data storage services, security services, etc. Accordingly, remote devices 110 can include a conventional hardware arrangement and can be outfitted with software and/or firmware for performing web server functions for performing aspects of the present invention, such as, for example, javascript/jquery, HTML5, CSS2/3, and facilities for SSL, MySQL, PHP, SOAP, etc.

Remote devices 110 may be coupled with a data storage facility, which may include one or more local or remote memory systems or units, and can include one or more databases and/or file systems for storing data, media, graphics, HTML documents, XML documents, etc.

Remote devices 110 can be configured to include an admin function, which enables an administrator to perform system-related functions. The system-related functions can include maintaining user records, performing upgrades on the software and topic content, and the moderation of tasks.

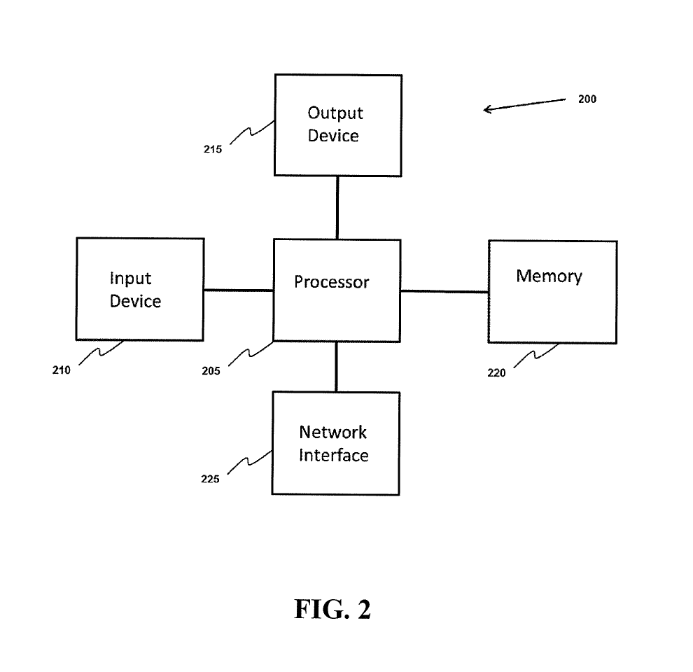

Referring to FIG. 2, a block diagram of a device 200, such as for example, user device 105, computer 120, tablet 125, and mobile device 130, in accordance with exemplary embodiments of the present invention is illustrated. As shown in FIG. 2, the device 200 may include a processor 205, which may include one or more microprocessors and/or one or more circuits, such as an application specific integrated circuit (ASIC), field-programmable gate arrays (FPGAs), etc.

The device 200 may include a network interface 225. The network interface 225 is configured to enable communication with a communication network, using a wired and/or wireless connection.

The device 200 may include memory 220, such as non-transitive, which may include one or more non-volatile storage devices and/or one or more volatile storage devices (e.g., random access memory (RAM)). In instances where the device 200 includes a microprocessor, computer readable program code may be stored in a computer readable medium or memory, such as, but not limited to magnetic media (e.g., a hard disk), optical media (e.g., a OVO), memory devices (e.g., random access memory, flash memory), etc. The computer program or software code can be stored on a tangible, or non-transitive, machine-readable medium or memory. In some embodiments, computer readable program code is configured such that when executed by a processor, the code causes the device to perform the steps described below and herein. In other embodiments, the device is configured to perform steps described below without the need for code.

It will be recognized by one skilled in the art that these operations, algorithms, logic, method steps, routines, sub-routines, and modules may be implemented in software, in firmware, in special purpose digital logic, and any combination thereof without deviating from the spirit and scope of the present invention as recited within the claims attached hereto.

The device 200 may include an input device 210. The input device is configured to receive an input from either a user or a hardware or software component. Examples of an input device 210 include a keyboard, mouse, microphone, touch screen and software enabling interaction with a touch screen, etc. The device can also include an output device 215. Examples of output devices 215 include monitors, televisions, mobile device screens, tablet screens, speakers, remote screens, etc. The output device 215 can be configured to display images, media files, text, or video, or play audio to a user through speaker output.

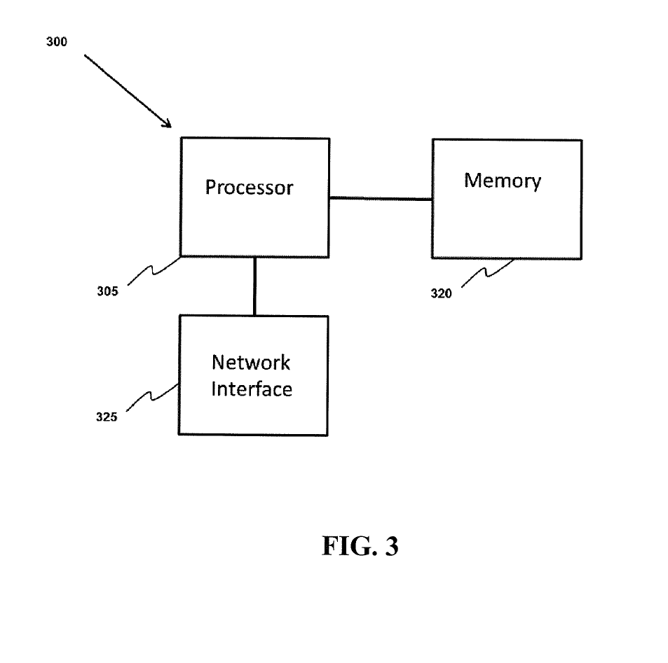

Referring now to FIG. 3, a block diagram of a remote device in accordance with exemplary embodiments of the present invention is illustrated. As shown in FIG. 3, the remote device 300 may include a network interface 315 for transmitting and receiving data, a processor 305 for controlling operation of the server device 300, and a memory 310 for storing computer readable instructions (e.g., software) and data. The network interface 315 and memory 310 are coupled to and communicate with the processor 305. Processor 305 controls the operation of network interface 315 and memory 310 and the flow of data and functionality between them. In various embodiments inputs can come from the device 200, to the remote device 300, via the network interface 315. Processing can occur at the remote device 300, at the device 200, or at both. In various embodiments, remote device 300 may be a server.

Processor 305 may include one or more microprocessors, and/or one or more circuits, such as an application specific integrated circuit (ASIC), field-programmable gate arrays (FPGAs), etc. Network interface 225 can be configured to enable communication with a communication network, using a wired and/or wireless connection. Memory 310 can include one or more non-volatile storage devices and/or one or more volatile storage devices (e.g., random access memory (RAM)). In instances where remote device 300 includes a microprocessor, computer readable program code may be stored in a computer readable medium, such as, but not limited to magnetic media (e.g., a hard disk), optical media (e.g., a DVD), memory devices (e.g., herein. In other embodiments, the device is configured to perform steps described below without the need for code. It will be recognized by one skilled in the art that these operations, logic, method steps, routines, algorithms, sub-routines, and modules may be implemented in software, in firmware, in special purpose digital logic, and any combination thereof without deviating from the spirit and scope of the present invention as recited within the claims attached hereto.

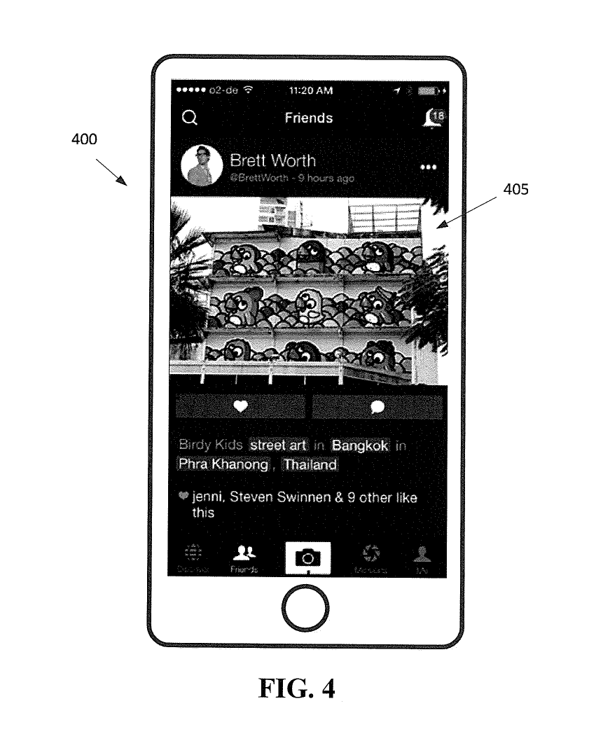

Referring now to FIG. 4, an exemplary screen of a requested image in accordance with exemplary embodiments of the present invention is provided. In an embodiment of the present invention, a user device 400 such as a mobile phone contains a program that displays an image 405 requested by a user. The user uses an application program and may scroll through a feed of images until the user reaches the image 405 desired for viewing. In a particular embodiment, the image viewing capabilities may be implemented using the JTSImageViewController library.

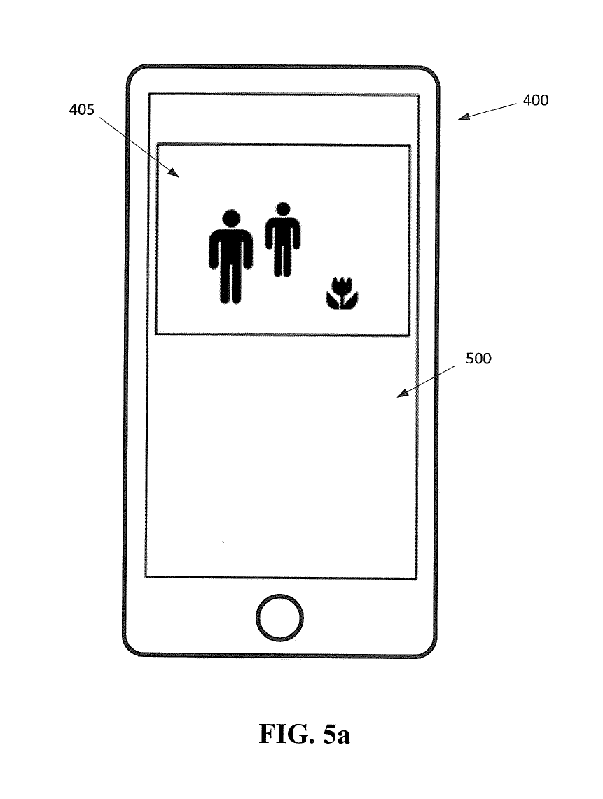

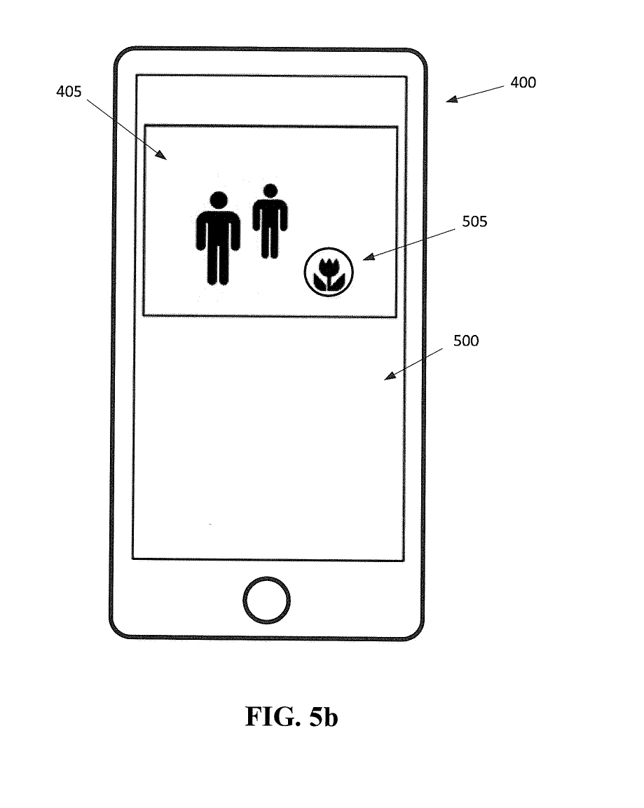

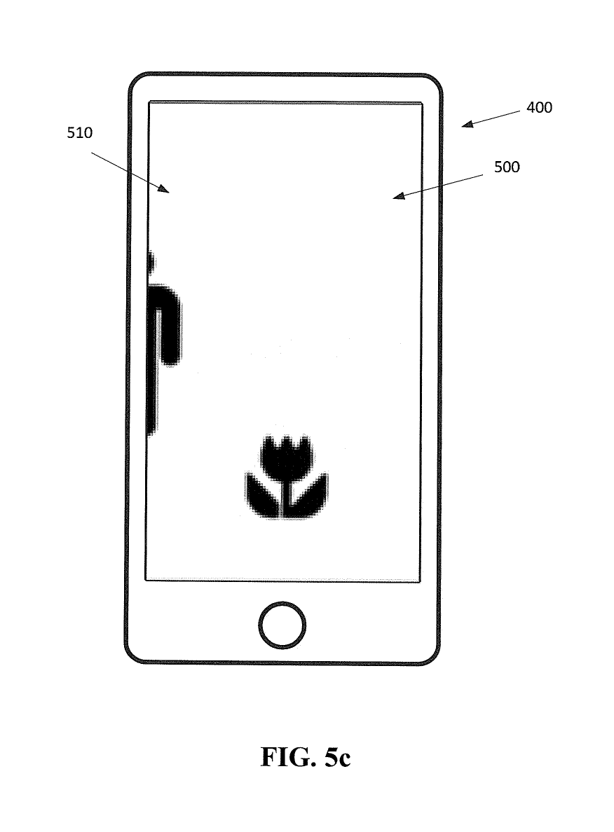

Referring now to FIG. 5a, an exemplary screen of a requested image in accordance with exemplary embodiments of the present invention is provided. In an embodiment of the present invention, a user device 400, such as a mobile phone, contains a program that displays an image 405 requested by a user, similar to FIG. 4. Image 405 is displayed on the user device 400 viewport 500, partially covering the viewport. The viewport represents a display screen on the user device 400.

FIG. 5b is an exemplary screen of a selection made via single user input on the image indicating a desired zoom location in accordance with exemplary embodiments of the present invention. In an exemplary embodiment, the user device 400 receives single user input 505 when a user presses or taps a location on the touch screen interface of the user device 400. The circle 505 represents the area pressed or tapped by the user on image 405.

FIG. 5c is an exemplary screen displaying the enlarged image in accordance with exemplary embodiments of the present invention. In an embodiment of the present invention, after receiving the single user input, the image displayed on the user device 400 is enlarged. The enlarged image 510 is scaled so that the vertical height of the image is equal to the vertical distance of the display screen 500 of the user device.

In one particular embodiment, the zoom occurs through a “directional zoom” feature where an animation scales the image to the enlarged state. This animation occurs instead of statically showing the originally-sized image followed by statically displaying the enlarged image without a transition animation.

In another embodiment, FIG. 5c shows the location of the high resolution image described in step 735 of method 700. When the high resolution image replaces the enlarged image 510, the high resolution image will assume the same position and have the same size as the enlarged image.

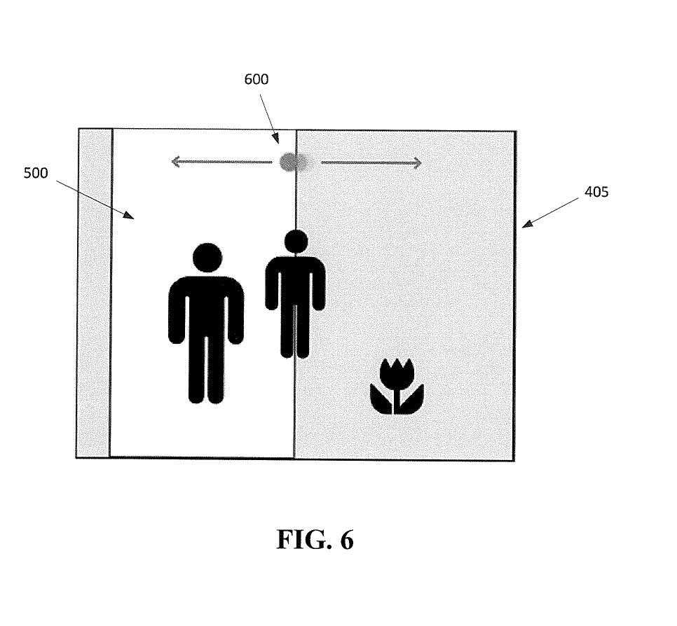

FIG. 6 is an exemplary screen of a viewport being movable horizontally in accordance with exemplary embodiments of the present invention. In an embodiment of the present invention, after the image 405 has been enlarged or replaced with a high resolution version of the image, a user may continue to explore the image by moving the image horizontally. The user input 600 may be in the form of dragging a finger along a user device's touch screen. User input 600 then moves the image displayed on the display screen 500. In another embodiment, the vertical height is fixed so that the user may more easily move the image horizontally without concern for vertical movement.

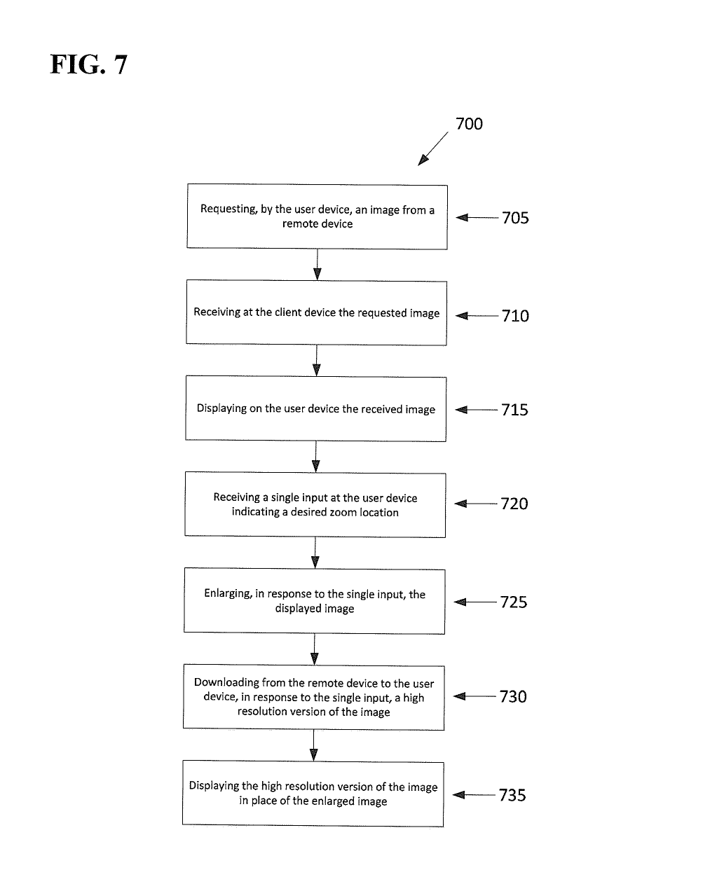

FIG. 7 is a flow diagram illustrating steps of a method for enlarging an image in accordance with exemplary embodiments of the present invention. In an embodiment of the present invention, method 700 includes requesting, by the user device, an image selected by the user from a remote device (step 705). In certain embodiments of the present invention, a user may be using a mobile application on a user device and can scroll through a list or feed of images. When a user scrolls to an image, a first request containing 1) an identification of the specific image and 2) the size of the screen of the user device is sent to a remote device. In a particular embodiment, the image viewing capabilities may be implemented using the JTSlmageViewController library.

Next, in method 700, the user device receives the requested image (step 710). In certain embodiments of the present invention, the image received is in the form of a link to the image. Using the width of the device screen sent from step 705, the remote device sends an image link to the device wherein the width of the image matches the width of the device screen. The remote device may also send to the user device an echo of the image identification from step 705, information about the user who captured the image (e.g. a unique user name, a full name, a link to a profile picture file), or information about the photo meta data (e.g. time stamp from when the image was captured or uploaded, number of “likes” or comments, latest three comments).

Next, in method 700, the user device displays the received image (step 715). In one particular embodiment, if the user device received an image link from the remote device, the user device resolves the link so the user sees the image instead of a textual link.

Next, in method 700, the user device receives a single input from the user that indicates a desired zoom location (step 720). In one particular embodiment, the user device comprises a touch screen display allowing a user to tap with a finger on the displayed image. The user device then recognizes the tapped location and registers this location as the desired zoom location.

Next, in method 700, the user device, in response to the single input, enlarges the displayed image (step 725). In one particular embodiment, the user device scales the displayed image so that the vertical height of the displayed image equals the vertical distance of the user device screen. Further, the enlarged image is centered on the display screen horizontally based on the desired zoom location.

In another embodiment, the image is locked in the vertical direction, meaning that the image will not move in the vertical direction. The user instead has the capability to move the image in the horizontal direction to explore the image. The user also has the capability to zoom into the image further using traditional pinch to zoom techniques.

Next, in method 700, the user device downloads from the remote device, in response to the single user input, a high resolution version of the image (step 730). In one particular embodiment, the user device sends a request to the remote device for a high resolution version of the image that has a vertical height equal to the vertical distance of the user device screen. This practice optimizes downloading a high image quality while reducing unnecessary download time.

In another embodiment, step 730 may occur simultaneously with step 725 so that the high resolution image is downloaded in the background while the device displays the enlarged version of the originally-requested image.

Next, in method 700, after the user device has downloaded the high resolution image from the remote device, the enlarged image is replaced with the high resolution image (step 735). In one particular embodiment, the high resolution image will be the same size as the enlarged image. Thus, the high resolution image will directly map to the already-displayed enlarged image. The high resolution image will have the same vertical height and will also be centered horizontally at the desired zoom location.

In certain embodiments, the user will be able to exit the zoomed image using a single input to the user device. Upon receiving the single input, the display returns to the view seen after completing step 715. The user may then zoom into the image again using another single user input via step 720.

In embodiments where a processor is included, computer readable program code (CRPC) may be stored in a computer readable medium, such as, but not limited, to magnetic media (e.g., a hard disk), optical media (e.g., a DVD), memory devices (e.g., random access memory), and the like. In some embodiments, computer readable program code is configured such that when executed by a processor, the code causes the processor to perform steps described above (e.g., steps described above with reference to the flow chart shown in FIG. 7).

While various embodiments have been described above, it should be understood that they have been presented by way of example only, and not limitation. Thus, the breadth and scope of the present disclosure should not limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

We claim:

1. A method for enabling a user to enlarge a displayed image on a user device, comprising:
requesting, by the user device, an image selected by the user from a remote device;
receiving at the user device the requested image;
displaying on the user device the received image;
receiving a single input at the user device indicating a desired zoom location;
enlarging, in response to the single input, the displayed image, wherein the vertical height of the enlarged image equals the vertical distance of the user device screen and the desired zoom location centers the enlarged image horizontally;
downloading from the remote device to the user device, in response to the single input, a high resolution version of the image; and
displaying the high resolution version of the image in place of the enlarged image.

2. The method of claim 1, wherein the single input is a single tap on a display screen.

3. The method of claim 1, further comprising, locking the displayed image vertically.

4. The method of claim 1, further comprising, enabling the user to freely drag the enlarged or high resolution image horizontally.

5. The method of claim 1, further comprising, enabling the user to further zoom-in to the image by pinching to zoom.

6. The method of claim 5, further comprising, automatically returning back to the displayed image after the user releases the further zoom.

7. The method of claim 1, further comprising, returning to the originally-sized image after receiving another single input on the display screen.

8. The method of claim 1, further comprising, receiving two inputs when viewing the enlarged or high resolution image to display the image at full horizontal width.

9. The method of claim 8, further comprising, receiving two inputs when viewing the image at full horizontal width to return to the enlarged or high resolution image.

10. The method of claim 8, wherein the two inputs are a double tap on a display screen.

11. The method of claim 1, wherein downloading a high resolution version of the image is dependent on the display size of the user device.

12. The method of claim 11, wherein the high resolution image downloaded has a vertical height equal to the vertical height of the display screen on the user device.

13. The method of claim 1, wherein the remote device is a server.

14. A user device for enabling a user to enlarge a displayed image received from a remote device, comprising:
a processor;
a memory coupled to the processor;
a display screen coupled to the processor; and
a network interface coupled to the processor,
wherein the processor is configured to:
receive a request from the user for an image;
transmit, using the network interface, the request for an image to the remote device;
receive, using the network interface, from the remote device the requested image;
display the received image on the display screen;
receive a single input from the user indicating a desired zoom location;
enlarge, in response to the single input, the displayed image, wherein the vertical height of the enlarged image equals the vertical distance of the display screen and the desired zoom location centers the enlarged image horizontally;
download from the remote device, in response to the single input, a high resolution version of the image; and
display the high resolution version of the image in place of the enlarged image.

15. The user device of claim 14, wherein the single input is a single tap on a display screen.

16. A computer program product enabling a user to enlarge a displayed image received from a remote device, said computer program product comprising a non-transitory computer readable medium storing computer readable program code embodied in the medium, said computer program product comprising:
program code for causing a user device to receive a request from a user for an image;
program code for causing the user device to transmit the request to the remote device;
program code for causing the user device to receive the requested image;
program code for causing the user device to display the received image;
program code for causing the user device to receive a single input from the user indicating a desired zoom location;
program code for causing the user device to enlarge the image displayed on the user device screen, wherein the vertical height of the enlarged image equals the vertical distance of the display screen and the desired zoom location centers the enlarged image horizontally;
program code for causing the user device to download from the remote device, in response to the single input, a high resolution version of the image; and
program code for causing the user device to display the high resolution version of the image in place of the enlarged image.

17. The computer program product of claim 16, wherein the single input is a single tap on a display screen.
